(19) United States
(12) Patent Application Publication
(10) Pub. No.: US 2002/0162794 A1
(43) Pub. Date: Nov. 7, 2002

(54) Anaerobic digestion

(76) Inventor: Richard William Tock, Lubbock, TX (US)

Correspondence Address: Henry Croskell, 6817 Cliffbrook, Dallas, TX, 75240, US

(21) Appl. No.: 09/794,414

(22) Filed: Feb. 27, 2001

(51) Int. Cl. C02F 3/28

(52) U.S. Cl. 210/610; 435/244

(57) ABSTRACT

A chemical additive is taught for the improvement of anaerobic digestion treatment of water-borne organic biomass by the addition of at least about 500 ppm or greater of a formate salt or mixtures of formate salts, the added presence being based on the total solids content of the organic based biomass in the wastewater stream, with the formate salts enhancing the anaerobic microbial activity in an anaerobic digestion zone and thereby promoting reduction of residual sludge of the biomass and reduction of chemical oxygen demand for the biomass digestion. The formate salts can be added by mixing the soluble salts with the water-borne organic biomass, or in the alternative by producing the formate salts insitu by adding formic acid to the biomass in the presence of at least about 100 mg/:based on the total biomass solids content followed by addition of appropriate amounts of base materials to complete the formation of the dissociated salts so as to maintain the wastewater in the appropriate pH range.

### BACKGROUND OF THE INVENTION

1. Field of the Invention

The present invention relates to a new and useful chemical additive, which aids anaerobic digestion and municipal wastewater treatment. In another aspect, the invention is concerned with a more complete and rapid reduction in chemical oxygen demand of anaerobic digestion processes, which contains the additive. In yet another aspect, the invention relates to an increase in the levels of dissolved solids following digestion corresponding to a reduction of residual sludge requiring disposal. The invention directly relates to a methodology designed to promote anaerobic digestion utilizing formate salts. The use of formate salts as taught by this invention can result in a reduction of the initial sludge solids, and thereby exert a more positive impact on the treatment of municipal wastewater, certain industrial waste water, and most agriculturally derived wastewater when they are subjected to anaerobic digestion.

2. Description of Prior Art

It can be correctly assumed that anaerobic habitats have existed continuously throughout the time that life has been present on earth. This is true even though during the last few billion years aerobes have exerted their dominance through an evolved utilization of oxygen generated by photosynthetic organisms. In the current, relatively rich oxygen environments anaerobic habitats still arise whenever decaying organic materials accumulate within aquatic regions. In the bio-mineralization processes that convert organic carbon atoms into carbon dioxide molecules, the rapid growth of aerobes and facultative microorganisms can consume and deplete the local oxygen levels to the extent that anaerobic conditions are created and anaerobes then proliferate.

With a photosynthetic, oxygen enriched atmosphere, organisms (prokaryotes and eukaryotes) have evolved that utilize organic molecules during oxidative metabolism. It is this mineralization of organic matter, which allows a tremendous increase in the efficiency of the aerobic organism's net metabolic energy. Although other organisms do not require oxygen in their metabolism, it has been the eukaryotes that have evolved and diversified as oxygen dependent organisms. Aerobic organisms, as their name implies, have evolved to produce enzymes that are used to detoxify the oxygen radicals in the aerobe's surroundings. Although aerobic organisms depend on oxygen for metabolic energy, with only a few exceptions, they do not use elemental oxygen in their synthetic pathways. It is as if free oxygen began to have an impact on the evolution of life at a time long after the biochemical mechanisms for anaerobic life had been developed.

Because anaerobes failed to evolve a system of protective enzymes, anaerobic organisms can exist only by successfully avoiding uncombined oxygen. Hence, most anaerobic ecosystems are fueled almost entirely by non-living organic materials; typically plant debris imported from aerobic surroundings. Under anaerobic conditions, fermenting bacteria utilize their enzymes to decompose or break down large, complex organic molecules of biomass residues into simpler sugars and amino acids that are water soluble and metabolically compatible. The dissolved compounds are then transported through the cell walls of the microorganisms where they are fermented and in the process provide energy for the bacteria.

Many other types of bacteria use the excreted metabolites produced by fermentation bacteria. In those environments where oxygen-supplying sulfate ions remain in low concentrations, such as in deep lakes and sewage digesters, methane-producing bacteria are responsible for the carbon thermal mineralization process. Bio-methanogens are capable of obtaining energy for growth by converting molecular carbon dioxide and hydrogen into methane and water. Some methanogenic bacteria are also capable of transforming acetate into methane and carbon dioxide. When lake sediments are agitated, the bubbles of methane that rise to the surface because of the disturbance are evidence of the methane forming activity of these bacteria.

Although many of the isolates of methanogenic and other bacteria have been obtained from anaerobic digesters, there has been comparatively little investigative work undertaken to determine the actual numbers in which the bacteria exist, the variations in their numbers with time and the operational factors of the digesters, and the relationships that exist between the different types of bacteria. By contrast, there is a significant body of knowledge based on the anaerobic, microbial ecology of the mammalian rumen system. For whatever reason, a similar body of knowledge has been much slower to develop for non-rumen, anaerobic digesters.

Experiments suggest that mechanical anaerobic digesters probably contain a much more varied population of cellulolytic bacteria than does the animal rumen where three or four genera and species are seen to comprise the main cellulolytic population, and where clostridia are uncommon. In mixed anaerobic digester cultures some bacteria may demonstrate more and less cellulolytic activity than individual bacteria, but most showed no or only slight symbiotic or antagonistic interactions. Some Clostridium isolates from mechanical digesters are known to produce factors, which inhibited other isolates. However, it has been suggested that these interactions are probably confined to localize areas of plant fibres colonized by bacteria, since the population of the mixed culture seemed to remain in a “dynamic” steady state with no species, or group of species, becoming dominant.

Unlike the facultative E.coli and Streptococcus, cellulolytic bacteria are not known to be predominant organisms in the human or animal gut and do not enter digesters in large numbers. Rather cellulolytic bacteria seemed to have been selected for growth in the digester from bacteria making up a small proportion of the bacterial population in the digester feedstocks. Only low levels of rumen cellulolytic bacteria are found in pig or cattle-waste digesters and previous experiments have shown that such cellulolytic rumen bacteria introduced into a digester treating pig-waste and straw experienced only transitorily survival. However, later tests with mixed cultures of bacteria from the cattle-waste digester and rumen cellulolytic bacteria showed no definitive antagonism between the digester and rumen bacteria.

Although work has been done on anaerobic waste digesters used to degrade fecal wastes from farm ruminants, these and other mechanical digesters exhibit few, if any, rumen bacteria. Digester microbial populations seem to differ in general from those of the rumen and some tests have suggested that bacteria cultured from rumen extract have a limited life when introduced into digesters. It is possible that the digester bacteria previously mentioned as being similar to rumen types may have simply adapted in some way to the digester conditions and are there after no longer like those found in the rumen. Although the temperature and the anaerobic conditions found in mechanical anaerobic digesters are similar to those in the rumen, the substrates found in each differ. The animal and human-waste feed stocks used in mechanical digesters are in general more difficult to degrade than the starch based substrates found in ruminant feeds. Moreover, the retention times of the substrates and bacteria in the mechanical digester systems are typically significantly longer than the rumen retention times. Other parameters, such as ammonia and VFA concentration levels in non-vivo digesters may differ from those found in the rumen. Since the anaerobic mixed cultures found in both types of reactors are well adapted to their habitats, it may not be surprising that the digester and rumen populations seem to differ. Given initial data for a mechanical digester, however, it would seem to be easier to generate a model for these digesters than to attempt to model rumen behavior, as the latter has “animal factors” or bio-feed back in addition to the complex microbial systems and feedstocks with which to contend.

It is generally not known whether all digesters treating the same, or very similar, waste will eventually reach a steady-state condition where they all have the same microbial population. Usually, the final population depends equally on the starting inoculum and other “unknown factors”. With respect to this invention, it is believed that the controlled addition of sodium formate to any mixed culture will change the microbial distribution of the mixed culture over time.

Digesters now commercially running or that are being tested on a pilot or laboratory scale are frequently started without knowledge of the bacteria included in the mixed culture. But by using relatively simple procedures, which are known to encourage the formation of a stable digestion regime, the inoculum's microbes adjust and grow in relative numbers constantly adapting to the conditions in the digester.

Anaerobic processes have always been an integral part of waste water treatment programs. In a septic tank, one of the oldest and often used applications in municipal sewage treatment, the vast majority of microbial mineralization reactions take place under anaerobic conditions. However, the popularity of mechanical anaerobic treatment systems has diminished in recent decades because aerobic and physical-chemical methods have become attractive alternatives. Aerobic and physical-chemical treatment process can exhibit demonstrative economic advantages in operation and impurity removal efficiency. However, the energy crisis in the early 70's and the rapid growth of biotechnology have rekindled interest in anaerobic processes. Today the use of anaerobic microorganisms covers a wide array of applications ranging from the field of wastewater treatment to “high tech” genetic engineering that frequently utilizes enzyme technology.

Anaerobic processes have been used historically in the overall treatment of municipal and industrial wastewater sludges. The anaerobic phase of the wastewater treatment is a polishing process that converts organic solids through bioaction pathways into methane, a fuel that can yield an energy gain from process operations. Because of recent advantages in treatment technologies and knowledge of process microbiology, applications of this technology are available for treatment of many dilute industrial wastewaters generated during food processing as well.

In wastewater treatment practice, anaerobic digestion has traditionally been employed to stabilize municipal sludges for ultimate disposal and to provide methane as a secondary source of energy. Accordingly, most of the research and development efforts have focused on the methane-generating phase of the process. Little attention has been given to what is called the acid-phase of digestion. This phase consists of promoting favorable conditions by which complex organic substances such as carbohydrates, proteins and lipids are converted anaerobically to volatile fatty acids and other lower molecular weight, water-soluble carbon compounds.

Complex organic materials are first hydrolyzed and fermented by anaerobic microorganisms into fatty acids. The fatty acids are then oxidized by beta-oxidations to produce hydrogen and acetate, through processes termed dehydrogenation and acetogenesis, respectively. The last stage of the bio-pathway is methanogenesis. Although there are other ways in which methane can be formed, the two listed pathways tend to be most significant in the anaerobic treatment of wastewaters.

More easily fermentable materials, i.e. residues rich in fatty acids, monomeric sugars and the like, provide a fermentation process where the limiting step is generally the methanogenic step corresponding to either a methanogenic reduction of bicarbonate, dehydrogenation, oxidizing methanogenic bacteria or an acetoclastic methanogenic fermentation. On the other hand, during the anaerobic digestion of complex materials such as agricultural wastes, which are mainly composed of cellulosic and small quantities of lipids and proteins, the limiting step of the process is often (1) fermentable organic fragments; (2) dehydrogenation; (3) acetogenesis; and (4) methaanogenesis. It is the methanogenic step, which is universally is considered to control and limit the overall conversion of organic matter to methane, carbon dioxide and hydrogen sulfide. However, other progressions for the digestion process have been noted. Grobriki and Stuckey (1989) hypothesized that formic acid was an overlooked component in anaerobic processes. They noted that formic acid has been known to be produced during anaerobic digestion. Moreover, according to their last hypothesis, all mixed anaerobic cultures probably contain methanogens, which convert formate directly to methane.

The biochemical pathways in the anaerobic digestion of several different types of feedstocks have been well described and only some details remain to be filled in for a more complete understanding of the process. Bacteria, which will carry out the desired reactions, have been cultured. Howsoever, many of these isolates have come from digesters with different feed-stocks and may contain low level variations. More over, there have been few attempts made to study the systematic culture of a range of bacteria to be used to carrying out specific reaction pathways in one digester. Also, much remains to be done in analysis of the long-term stability of the digester flora. Similarly, as noted earlier, very little is known about whether all digesters treating the same, or very similar, waste have the same microbial populations, or whether the resulting population depends only on the starting inoculum or other as yet unknown factors.

The most important motive for direct anaerobic treatment of municipal, industrial, or agricultural wastewater is the low rate of biomass production per unit of substrate. Indeed, treatment and disposal of sewage sludge or “waste biomass” is technically cumbersome and economically a heavy burden. Obviously, there is a need for improved anaerobic digestion. In the following narrative, we teach that an improvement can be accomplished by a simple, economically, and environmentally safe chemical addition that ultimately reduces the amount of sludge production generated in the direct anaerobic treatment of wastewater biomass.

### SUMMARY OF INVENTION

The present invention teaches the use of the addition of formate salts at reasonably low levels of concentration as a means of enhancing the anaerobic digestive processes. Various formate salts and mixtures of formate salts have been shown to enhance anaerobic digestion processes which substantially reduce biomass sludge. These formate salts singly and in combination have been shown, according to the invention, to enhance the digestion of municipal, industrial and agricultural sludge. This is evidenced by a reduction of COD levels and by an increase in the levels of dissolved solids following digestion. The latter effect reduces the amount of sludge that remains. The use of formate salts in the manner just described imports a positive impact on the treatment of municipal wastewaters and sludges, feedlot wastewater treatment, industrial food processing wastewater treatment and similar wastewater treatment processes that use anaerobic digestion. The addition of formate salts, as opposed to just formic acid, has been shown to change the microbial distribution of the mixed culture. Such formate salts as sodium and potassium are shown to be effective in sewer digestion, with potassium formate actually having an added benefit for land applications where soils are fertilized by sludge. The present invention teaches the use of formate salts in relatively low concentrations to enhance the digestion of water borne organic waste or biomass by anaerobic processes. In doing so, it also reduces the COD level of the wastewater at a more rapid rate. More importantly, residual sludge levels are reduced, thus saving disposal cost.

### BRIEF DESCRIPTION OF DRAWINGS

FIG. 1 is a bar graph showing one effect of sodium formate addition on an anaerobic digestion. The formate assists with buffering the pH to a more desirable level as shown;

FIG. 2 is a bar graph showing the effect of added formate (ppm) on Chemical Oxygen Demand of an anaerobic digestion system;

FIG. 3 is a graphic interpretation of sodium formate concentrate (ppm) versus the percent increase in COD reduction; and

### DETAILED DESCRIPTION OF THE INVENTION

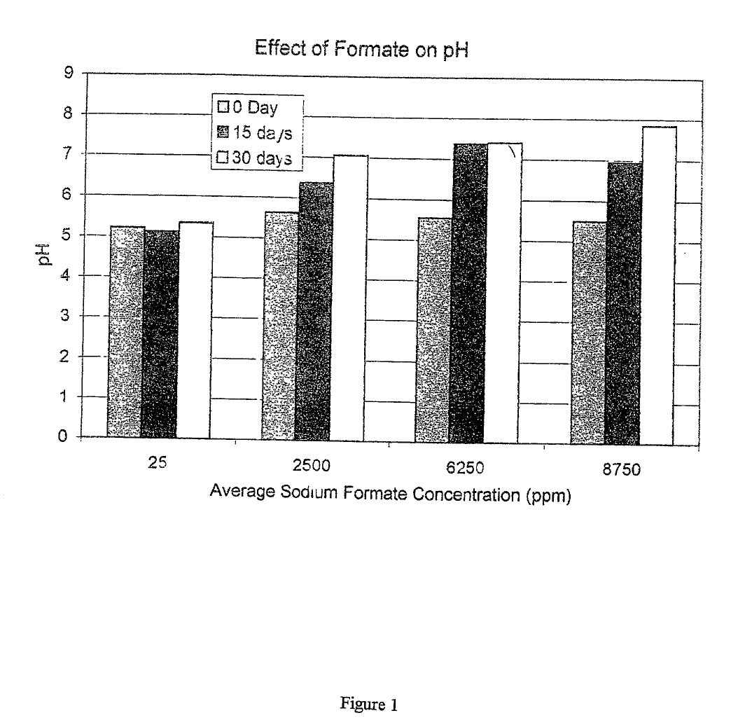

The bargraph (FIG. 1) shows the titration impact of sodium formate concentration (ppm) on the pH level over time in an anaerobic digester. The bar graph covers a concentration range of 25 ppm sodium formate to a high of 8,750 ppm. Three time elapsed pH readings are shown for 0 days, 15 days, and 30 days following each sodium formate addition. The overall teaching of FIG. 1 demonstrates that sodium formate has a buffering effect that tends to drive the pH in a digester toward a pH range that is considered to be desirable for anaerobic digestion. The addition of formic acid rather than a formate salt will not do this. The addition of typical buffering solutions is also not highly effective for adjusting the pH of anaerobic mixed cultures

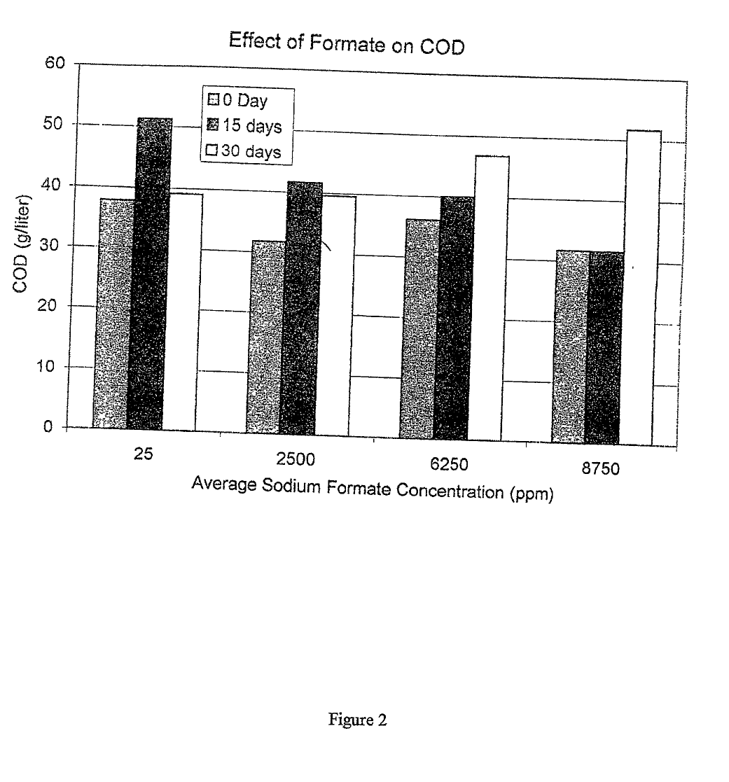

FIG. 2 shows the effect derived from the addition of sodium formate at different concentrations (25 to 8,750 ppm) on COD levels of the culture as a function of time. Again, time intervals of 0 days, 15 days and 30 days are shown. The COD concentration is expressed in grams per liter with the overall effect as shown by this figure of an approximate 10% difference, i.e. COD reduction due to the formate.

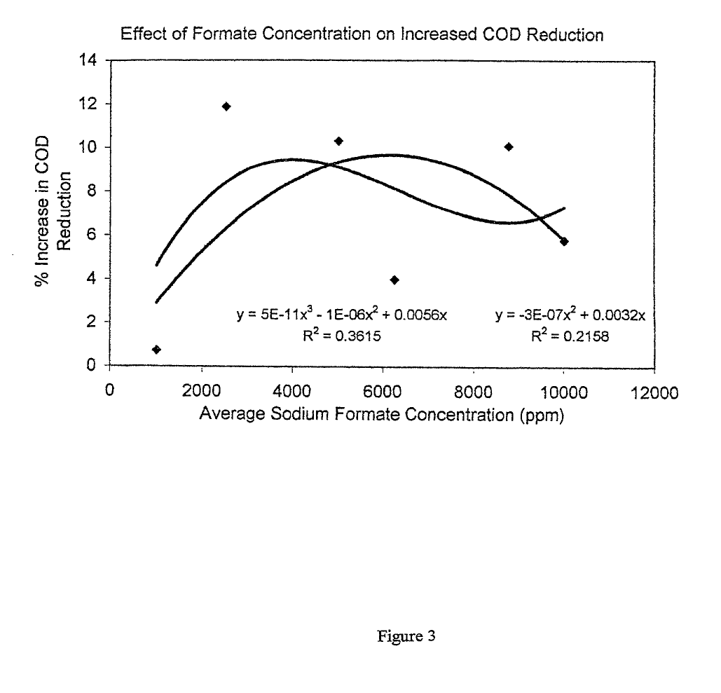

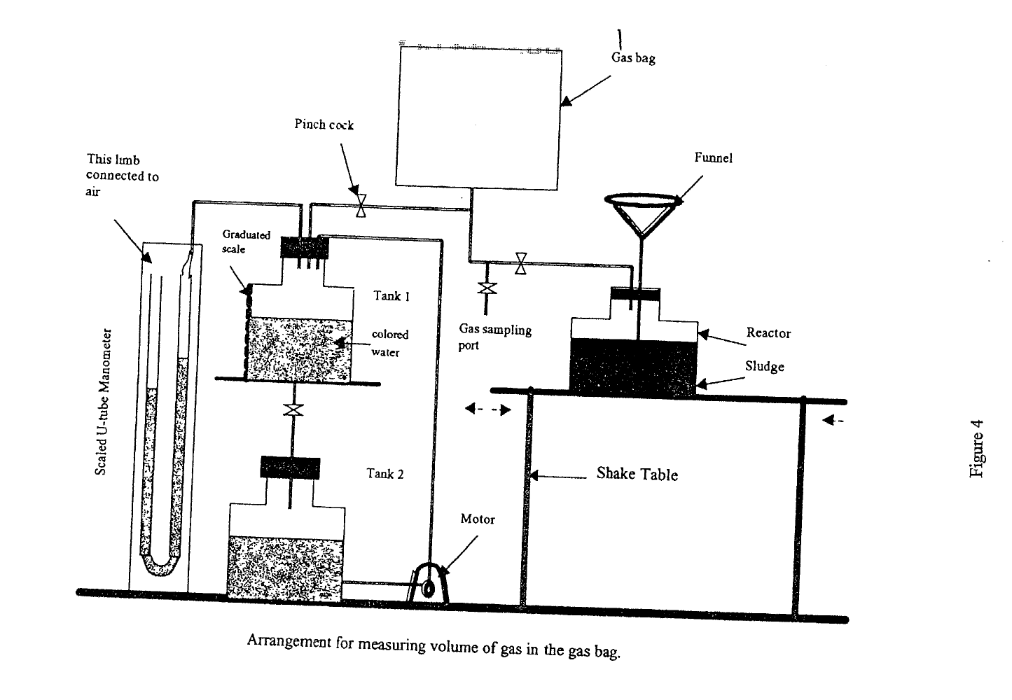

FIG. 3 is a graphic interpretation of the effect of formate concentration on increased COD reduction. Average sodium formate concentration (ppm) is shown from 0 to 12,000 versus percentage increase in COD reduction. From 0 formate up to about 5,000-7,000 ppm shows an increase from 0 to about 10% increase in COD reduction.

The present invention has demonstrated that it is the formate salts which are, in practice, beneficial to the anaerobic digestion. The various formate salts include, but are not limited to sodium formate (NaHCOO), potassium formate (KHCOO), ammonium formate (NH₄COO), calcium formate (Ca(HCOO)₂), and others either singly or in combination. These formate salts have been tested for concentrations ranging from 10 mg/L (˜10 ppm) to as high as 120% (100,000 mg/L) based on the organic matter available for digestion. Over this range of concentration, only the ammonium formate was found to initiate the inhibition of digestion at concentrations above a few thousand mg/L. Sodium and potassium formate salts were beneficial at all concentration levels with the greatest effects being observed over the 100 ppm to the 2,000-mg/L range.

To some extent, the study of microbiology of digesters is academic. Mechanical digesters now commercially running, or being tested on pilot or laboratory scale, have been started without knowledge of the bacteria involved. Instead, relatively simple processes that are known to allow stable digestion regimes to be attained are utilized. This approach allows the inoculum bacteria to adjust their relative numbers and adapt to the digestion conditions. Again, two-phase, retained-biomass, and other types of digesters have been designed without detailed knowledge of the bacterial populations but on some “rules of thumb” found from observation of the behavior of digesters or the overall properties of some metabolic groups of bacteria; hydrolytic methanogenic, etc. Nevertheless, more knowledge of the makeup of digester flora is worthwhile from an academic need for better knowledge of the bacteria in complex, mixed populations (and such knowledge will be put to use in improving anaerobic digestion in the future as greater efficiency and digestion of more recalcitrant feedstocks is demanded). The addition of formate salts in catalytic amounts (ppm) encourages same.

The use of formate salts is the preferred teaching over the use of formic acid itself because the actions associated with the salts are reasoned to assist as buffers for electron transfer processes. This action of the alkali ions frees the cationic hydrogen ions [H+] so that they can be used in the production of methane rather than being tied up with anionic formate ions [HCOO˜] where they may also be required in order to maintain an overall region of electrical neutrality.

The addition of formate salts to anaerobic processes that are used to digest organic matter biomass provides an enhanced reduction in the amount of sludge requiring disposal. Furthermore, the added formate salts shorten the time required for digestion. This latter aspect makes anaerobic processes more competitive with aerobic digestion, which traditionally takes less time and, hence, requires less volume or holding capacity. Thus it is envisioned that the use of formate salts can increase the capacity of current municipal, industrial and agricultural anaerobic digesters. It is highly significant if increased digester capacity can be accomplished through the simple and inexpensive addition of the soluble formate salts to the wastewater being treated. In another aspect, it is recognized that the formate salts could be produced insitu by addition of both formic acid and various inorganic bases to the wastewater. It also means that new digesters being considered for installation would have less expensive construction costs if the volume of the digestion tanks can be reduced in size.

The use of formate salts as enhancers for anaerobic digestion of water borne organic biomass waste is presented in the following examples:

Sodium formate is to be added to existing anaerobic digesters in use in currently operating POW treatment plants. The sodium formate is to be added at an average concentration of 1000 ppm (minus 500 ppm to a plus 1000 ppm) based on the COD concentration of the inlet waste stream. For example, if the inlet stream flow were 1000 gallons per hour with a COD concentration of 1000, ppm, the hourly rate of formate added would be:

Inlet liquid flow mass=1000 gph* (8 lb/gal)=8000 lb/hr

Inlet COD mass flow=8000 lb/hr×1000 ppm=8 lb COD/hr

Sodium formate required=8 lb/hr×1000 ppm×454 grams/lb

=3.6 grams/hr of sodium formate/1000 gph

*Where gph is gallons per hour

Under this scenario the addition of sodium formate would range from approximately 2.0 grams per hour to 9.0 grams per hour per 1000 gallons of wastewater per 1000 ppm of COD. The approximate cost for the sodium formate would range from $0.005 to ≦$0.020 per 1000 gallons per 1000 ppm of COD. The sodium formate would be added either as a granular powder or as a relatively concentrated solution. Sodium formate is highly water-soluble, so miscibility is not a problem. Moreover, our titration data indicate that the accidental addition of too much sodium formate would not shut down the digester culture as other chemical spike might do. This stability is due to the fact that the formate ion from the formate salt is itself a ready substrate for microbial digestion. As a viable substrate, therefore, the formate ion offers growth potential for many of the anaerobes with in the mixed culture.

Expected results from the addition of sodium formate at 1000 ppm based on COD levels would include better pH control in the anaerobic digester, and an ˜30% improvement in COD digestibility. The latter characteristic adds to the carrying capacity of the anaerobic digester.

Experimentally, the addition of sodium formate was found to facilitate the anaerobic digestion of domestic sewage. Two tests were run in which sodium formate in concentrations ranging from a few parts per million (ppm) up to ten percent (10%) on a mass basis were added to samples taken from a publicly owned anaerobic digester. The samples were first cultured in laboratory sized batch reactors. The twelve batch reactors were then sampled, and studied for periods of up to fifty-five days. The process variables that were monitored included COD (Chemical Oxygen Demand), TS (Total Solids), TVS (Total Volatile Solids) and the pH of the culture. Time and the initial sodium formate concentration level were the independent variables. Finally measurements were also made of the bacterial counts at the beginning and at the end of the fifty five day period. These experimental observations permitted partial identifications of the predominant bacterial colonies still viable in each of the twelve reactors used for each trial of the laboratory study.

Sodium formate was observed to facilitate the anaerobic digestion process at all concentration levels up to 5000 ppm. Above the 5000 ppm concentration level the cellular activity in the mixed culture became slightly, but still progressively more inhibited. However, the study demonstrated that the observed inhibition was time dependent. With time, even those reactors receiving levels of at least ten percent (10%) sodium formate recovered. This is highly atypical, since sodium levels alone (i.e. from a sodium chloride spike) are known to be toxic to all microorganisms in domestic sewage at levels above three to four percent. However, the afore mentioned microbial pattern identification studies of the active microbes following exposure to formate revealed that at the high levels of sodium formate, the original mixed culture had changed to a culture that significantly favored microbial yeast formations, i.e. yeast colonies proliferated in high formate environments. Yeasts are one of the three divisions of the kingdom Fungi. Fungi are known to take advantage of unusual habitats, and there appearance in a culture is sometimes taken as a sign of contamination. Our experiments revealed that rather than contamination, the yeasts were probably present in the original mixed culture from the sewage treatment plant. The presence of the added formate changed the culture enough to allow the yeasts to proliferate. Yeasts and other members of the fungi kingdom when combined with bacteria represent the principal decomposers of biomass. It is their activity that keep ecosystems stocked with carbon, nitrogen, and inorganic nutrients essential to the growth of all living organisms. We believe that our data teach that formate is needed at some threshold level as a means of optimizing the anaerobic digestion process.

The following is a summary of the three specific influences that the addition of sodium formate was found to have on the anaerobic digestion of domestic sewage sludge.

(1) At spiked concentration levels exceeding 1000 ppm by mass, the addition of sodium formate to domestic sewage helped maintain the pH of the mixed culture at or near the optimal range of 6.8-7.4 required for active anaerobic digestions. The capacity of pH adjustment with the use of sodium formate is believed to be derived from the formation of sodium bicarbonate and sodium carbonate. Both of these sodium salts are known buffers. As the formate ion is consumed by the mixed culture, either as a substrate for energy or to facilitate cellular biological activity, carbon dioxide is formed. Carbon dioxide in an aqueous environment forms carbonic acid, which in sufficient quantities can drive the pH of the solution to the acid range. However, if the carbonic acid is neutralized by the free, companion sodium ion as the acid is formed, then the observed buffering activity as expected will occur. The net reaction of the consumption of the formate ion, followed by the combination of sodium ions with the carbon dioxide that is formed, represents a novel way to facilitate the anaerobic process while avoiding excursions into pH conditions that are inhibitory to the anaerobic process. Simply adding a buffer to the anaerobic digester has been shown to be ineffective, but our novel approach using controlled addition of sodium formate has demonstrated capability to provide both a mechanism for pH control and a highly digestible substrate to facilitate microbial growth. The modification of pH levels is especially important for those anaerobic systems that are subject to periodic loading excursions of highly digestible substrates, where the buildup of acids can quickly trigger a crisis condition known as “acidosis” in rumen anaerobes.

(2) The addition of sodium formate to a laboratory scale, mixed anaerobic sewage digester was found to increase the bio-diversity of the mixed culture over a sodium formate concentration range of 1000-5000 ppm. Above this threshold, the addition of sodium formate was observed to induce some low level of culture inhibitions. With time these inhibitions lead to conditions in the mixed culture that appear to greatly facilitate the growth of yeast, perhaps to the exclusion of the other microbes. At all levels for the addition of sodium formate used in this study (100 ppm to 100,000 ppm), the bacterial counts ranged from 10⁷ CFU per milliliter to 10⁵ CFU per milliliter. The lower counts always occurred at the higher concentrations of the sodium formate, and lower counts are indicative of inhibition of biological activity for some part of the mixed culture. The fact that the counts remained at relatively high levels (>10⁵) is indicative that a significant fraction of the micro-organisms present in the original mixed culture are still viable even at the high sodium levels. As was pointed out previously, this may be because the sodium ion becomes quickly bound up as a bicarbonate or carbonate complexes, while the formate anion represents a ready substrate for cellular energy generation and growth.

The diversity found in the mixed culture following seeding with sodium formate was also revealing. The control sample taken from the publicly owned anaerobic digester had only two (2) identified colony types (Xanthomonas oryzae and Corynebacterium acquatricum. Obviously, there must be more colony types in this general mixed culture, but these two were identified as the predominant types. At sodium formate concentrations of 1000 ppm the predominant colony types had increased from two to eight, but only the Xanthomonas was still identifiable. The large numbers of colony types counted following three 10⁻⁴ dilution plates remained high even at the 10% sodium formate levels. However, at the 10% level, only Cellulomonas cellulans was identified along with large masses of yeast cells. No attempt was made at the time to identify yeast types. It is interesting that appearance of the Cellulomonas along with the yeast may signal an increased level of biological attack on the more difficult cellulose types of substrates found in domestic sewage. For whatever reasons Cellulomonas and yeast in these tests were less prevalent for conditions where sodium formate concentrations were nonexistent or low.

(3) COD levels and substrate levels were reduced in the presence of the added formate salts. We believe that the data teaches that these reductions are enhanced due to the effect of the formate to promote a more opportunistic distribution of the different microbes in the mixed culture.

In summary, it was demonstrated that the lower levels of sodium formate (≦5000 ppm) facilitate growth of some of the more dormant colonies in the mixed culture we obtained from a publicly owned waste treatment facility. Although diversity is the strength of a mixed culture, which allows it to adapt to a wide variety of substrate materials, for optimum performance, all portions of the mixed culture should be functional to some degree and not in a dormant mode. The data generated in this study indicate that at low concentrations of sodium formate (<5000 ppm), much more of the mixed culture becomes activated. The increased activity of more of the diverse microbe types should be reflected in greater reductions of COD concentration levels. In this study the addition of sodium formate at concentration levels ranging from 1000 ppm to 10,000 ppm was found to yield increase reductions of COD levels ranging from 4% to 12%.

One important measure of any anaerobic digestion process is the rate at which substrate materials are reduced by the biological activity. As noted in number (3), sodium formate was found to facilitate the anaerobic destruction of COD levels of domestic sewage. Although the average percent range in improvement reflected by the measured COD levels is not large (≦max 12%), this improvement remains significant for large domestic sewage treatment facilities that are usually already strained to the capacity. Moreover, through puts of existing large domestic sewer treatment facilities can be expected to be increased by at least 10%, probably by 20% to 30% over their life time. Moreover, in addition to a capacity increase of ˜10%, the use of sodium formate offers a potentially more sustainable mixed culture in terms of active diversity of microbe types, and significantly better pH control within the optimal range for anaerobic digestion. Although more testing is needed on non batch systems, it would appear that the continued addition of sodium formate at a level sufficient to achieve a concentration of 1000 ppm to 5000 ppm in the entering stream of a continuous anaerobic digester would be sufficient to significantly facilitate the performance of most domestic digesters.

The following Tables 1-5 summarize the results of these experiments:

Tables 1 and 2 illustrate pH results using formate salts in varying amounts for up to 55 days;

Table 3 illustrates colony forming units with varying parts per million of formate salts; and

Tables 4 and 5 illustrate COD results using varying parts per million for up to 30 days.

TABLE 1
pH RESULTS 1/4/99

| | Format Concentration | pH | | |
|---|---|---|---|---|
| | (ppm) | 0 Day | 15 days | 30 days |
| | 0 | 5.17 | 5.07 | 5.2 |
| | 0 | 5.21 | 5.09 | 5.22 |
| | 0 | 5.2 | 5.15 | 5.42 |
| | 100 | 5.3 | 5.22 | 5.54 |
| Average | 25 | 5.22 | 5.1325 | 5.345 |
| | 1250 | 5.54 | 6.06 | 7.1 |
| | 2500 | 5.69 | 6.29 | 7.2 |
| | 3750 | 5.65 | 6.8 | 6.86 |
| Average | 2500 | 5.626667 | 6.383333 | 7.053333 |
| | 5000 | 5.63 | 7.01 | 7.06 |
| | 6250 | 5.47 | 7.42 | 7.49 |
| | 7500 | 5.54 | 7.7 | 7.67 |
| Average | 6250 | 5.546667 | 7.376667 | 7.406667 |
| | 7500 | 5.54 | 7.7 | 7.67 |
| | 8750 | 5.52 | 7.33 | 7.8 |
| | 10000 | 5.44 | 5.82 | 8.06 |
| Average | 8750 | 5.5 | 6.95 | 7.843333 |
| | 25 | 5.22 | 5.1325 | 5.345 |
| | 2500 | 5.626667 | 6.383333 | 7.053333 |
| | 6250 | 5.546667 | 7.376667 | 7.406667 |
| | 8750 | 5.5 | 6.95 | 7.843333 |

TABLE 2
pH RESULTS 7/1/99

| | Format Co pH | 0 Day | 2 days | 3 days | 5 Day | 7 days | 9 days | 17 days | 25 days | 55 days |
|---|---|---|---|---|---|---|---|---|---|---|
| | 0 | 8.02 | 4.55 | 4.4 | 4.27 | 4.11 | 4.01 | 3.57 | 3.44 | 3.46 |
| | 0 | 8.04 | 4.51 | 4.3 | 4.15 | 4.01 | 3.87 | 3.55 | 3.44 | 3.42 |
| | 0 | 8.08 | 4.6 | 4.4 | 4.27 | 4.09 | 3.98 | 3.51 | 3.41 | 3.41 |
| Average | 0 | 8.047 | 4.55 | 4.367 | 4.23 | 4.07 | 3.953 | 3.543333 | 3.43 | 3.43 |
| | 1000 | 5.3 | 4.72 | 4.52 | 4.43 | 4.2 | 4.06 | 3.83 | 3.53 | 3.59 |
| | 1000 | 5.21 | 4.77 | 4.57 | 4.47 | 4.26 | 4.13 | 3.88 | 3.68 | 3.76 |
| | 1000 | 5.22 | 4.82 | 4.66 | 4.53 | 4.27 | 4.16 | 3.71 | 3.61 | 3.61 |
| Average | 1000 | 5.243 | 4.77 | 4.583 | 4.477 | 4.243 | 4.117 | 3.806667 | 3.606667 | 3.653333 |
| | 5000 | 5.08 | 5.08 | 4.85 | 4.76 | 4.5 | 4.37 | 4 | 3.99 | 4.06 |
| | 10000 | 6.42 | 5.64 | 5.28 | 5.25 | 5.01 | 4.67 | 4.21 | 4.17 | 4.25 |
| | 10000 | 6.29 | 5.49 | 5.1 | 5.1 | 4.97 | 4.69 | 4.55 | 4.19 | 4.25 |
| | 10000 | 6.5 | 5.51 | 5.18 | 5.19 | 4.78 | 4.48 | 4.21 | 4.13 | 4.21 |
| Average | 10000 | 6.403 | 5.55 | 5.187 | 5.18 | 4.92 | 4.613 | 4.323333 | 4.163333 | 4.236667 |
| | 100000 | 7.54 | 7.34 | 7.33 | 7.34 | 7.25 | 7.27 | 6.3 | 6.01 | 5.97 |
| | 100000 | 7.75 | 7.54 | 7.46 | 7.5 | 7.42 | 7.42 | 6.87 | 6.72 | 6.73 |
| Average | 100000 | 7.645 | 7.44 | 7.395 | 7.42 | 7.335 | 7.345 | 6.585 | 6.365 | 6.35 |
| | 0 | 8.047 | 4.55 | 4.367 | 4.23 | 4.07 | 3.953 | 3.543333 | 3.43 | 3.43 |
| | 1000 | 5.243 | 4.77 | 4.583 | 4.477 | 4.243 | 4.117 | 3.806667 | 3.606667 | 3.653333 |
| | 5000 | 5.08 | 5.08 | 4.85 | 4.76 | 4.5 | 4.37 | 4 | 3.99 | 4.06 |
| | 10000 | 6.403 | 5.55 | 5.187 | 5.18 | 4.92 | 4.613 | 4.323333 | 4.163333 | 4.236667 |
| | 100000 | 7.645 | 7.44 | 7.395 | 7.42 | 7.335 | 7.345 | 6.585 | 6.365 | 6.35 |

TABLE 3
Colony Forming Units Represented as Counts per Milliliter (mL) After 30
days Digestion

| Initial Formate Conc. | | | | |
|---|---|---|---|---|
| (ppm) Charged to the | | Average (10⁻⁷) | Upper (10⁻⁷) | Lower (10⁻⁷) |
| Batch Reactor | | Counts per mL | Counts | Counts |
| 0.00 | ppm | 1.87 | 1.90 | 1.80 |
| 1000 | ppm | 2.83 | 6.00 | 1.10 |
| 5000 | ppm | 0.59 | N/A | N/A |
| 10,000 | ppm | 0.28 | 0.38 | 0.19 |
| 100,000 | ppm | 0.21 | 0.38 | 0.04 |

TABLE 4
COD RESULTS 1/4/99

| | Format Concentration | COD Concentration (g/liter) | | |
|---|---|---|---|---|
| | (ppm) | 0 Day | 15 days | 30 days |
| | 0 | 27.7 | 87.5 | 34.1 |
| | 0 | 41.9 | 40.9 | 44.7 |
| | 0 | 52.2 | 69 | 38.6 |
| | 100 | 29.5 | 43.8 | 39.1 |
| Average | 25 | 37.825 | 51.23333 | 39.125 |
| | 1250 | 40.3 | 42.7 | 32 |
| | 2500 | 17.1 | 41.4 | 38.9 |
| | 3750 | 38 | 40.7 | 47.8 |
| Average | 2500 | 31.8 | 41.6 | 39.56667 |
| | 5000 | 37.5 | 43.1 | 46.6 |
| | 6250 | 34.3 | 44.1 | 38.1 |
| | 7500 | 36.7 | 33 | 55.8 |
| Average | 6250 | 36.16667 | 40.06667 | 46.83333 |
| | 7500 | 36.7 | 33 | 55.8 |
| | 8750 | 24.9 | 26.1 | 53.8 |
| | 10000 | 33.8 | 36.1 | 45.5 |
| Average | 8750 | 31.8 | 31.73333 | 51.7 |
| | 25 | 37.825 | 51.23333 | 39.125 |
| | 2500 | 31.8 | 41.6 | 39.56667 |
| | 6250 | 36.16667 | 40.06667 | 46.83333 |
| | 8750 | 31.8 | 31.73333 | 51.7 |

TABLE 5
COD RESULTS 7/1/99

| | Format Co COD Concentration (g/liter) | 0 Day | 1 days | 4 days | 7 Day | 9 days | 16 days | 24 days | 55 days | |
|---|---|---|---|---|---|---|---|---|---|---|
| | 0 | 57.2 | 57 | 49.8 | 56.6 | 52.1 | 30.9 | 28 | 41.9 | |
| | 0 | 52 | 51.5 | 52 | 65.8 | 54.9 | 33.1 | 59.2 | 34 | |
| | 0 | 60.8 | 60.3 | 51.46 | 8.2 | 48.5 | 41.4 | 11.2 | 46.6 | |
| Average | 0 | 56.67 | 56.3 | 51.07 | 63.53 | 51.83 | 35.13 | 32.8 | 40.83333 | |
| | 1000 | 48.6 | 57.2 | 52.3 | 50.3 | 47.7 | 33.6 | 39.4 | 38 | |
| | 1000 | 52 | 51.5 | 52 | 65.8 | 54.9 | 33.1 | 59.2 | 34 | |
| | 1000 | 60.8 | 60.3 | 51.4 | 68.2 | 48.5 | 41.4 | 11.2 | 46.6 | |
| Average | 1000 | 53.8 | 58.3 | 51.9 | 61.43 | 50.37 | 36.03 | 36.6 | 38.86667 | |
| | 5000 | 60.3 | 46.8 | 48.9 | 52.2 | 44.2 | 30.4 | 30.9 | 34.3 | |
| | 10000 | 58.2 | 50.7 | 47.3 | 56.4 | 49.9 | 38.2 | 40.8 | 49.7 | |
| | 10000 | 69 | 52.3 | 43.5 | 56.4 | 51.6 | 32 | 37.1 | 38.5 | |
| | 10000 | 36.7 | 45.5 | 43.2 | 44.3 | 43.7 | 40 | 40 | 32 | |
| Average | 10000 | 54.63 | 49.5 | 44.67 | 52.37 | 48.4 | 36.73 | 39.3 | 40.06667 | |
| | 100000 | 49 | 121 | 65.5 | 74.9 | 71 | 57.5 | 41.5 | 64.8 | |
| | 100000 | 64.4 | 165 | 87.1 | 94.5 | 89.6 | 67.1 | 25.6 | 73.9 | |
| Average | 100000 | 56.7 | 143 | 76.3 | 84.7 | 80.3 | 62.3 | 33.55 | 69.35 | |
| | 0 | 56.67 | 56.3 | 51.07 | 63.53 | 51.83 | 35.13 | 32.8 | 40.83333 | 48.51667 |
| | 1000 | 53.8 | 56.3 | 51.9 | 61.43 | 50.37 | 36.03 | 36.6 | 38.86667 | 48.16667 |
| | 5000 | 60.3 | 48.8 | 48.9 | 52.2 | 44.2 | 30.4 | 30.9 | 34.3 | 43.5 |
| | 10000 | 54.63 | 49.5 | 44.67 | 52.37 | 48.4 | 36.73 | 39.3 | 40.06687 | 45.70833 |
| | 100000 | 56.7 | 143 | 76.3 | 84.7 | 80.3 | 62.3 | 33.55 | 69.35 | 75.75625 |

| Format Concentration (ppm) | Averag % | |
|---|---|---|
| 0 | 48.52 | |
| 1000 | 48.17 | 0.72 |
| 5000 | 43.5 | 10.3 |
| 10000 | 45.71 | 5.79 |
| 100000 | 75.76 | −56.1 |

### Methods

The following techniques used to measure the various process variables and pH monitored in this study are as follows:

TS measurements

A 30 ml samples is withdrawn from each of the 12 reactors into refractory pans after the weight of empty pans was recorded (say W₁). The pans were then put into heated oven at 105° C. for at least 24 hours. The weight of pans with dried sample is then noted (say W₂). The difference W₂˜W₁, gives the weight of solids in 30 ml sample. From this the total Solids concentration in units of g/liter is calculated. This TS parameter is indicative of concentration of total solids in the sample including organic substrate, inert organics and inorganics.

TVS measurements

After the above TS measurements were completed, the pans together with dried samples are put into furnace at 550° C. for about two hours. The weight of the pans are then noted (say W₃). The difference (W₃-W₂) then gives the weight of volatile solids in the 30 ml sample. Again this Total Volatile Solids concentration is manipulated to units of g/liter. TVS determination represents the concentration of the organic substrate in the test sample.

Chemical Oxygen Demand (COD) measurements

To perform this measurement, a 5 ml of the sample from each of the 12 reactors is taken and diluted 10-fold to 50 ml. 5 ml of the now diluted sample is again diluted 10 fold to 50 ml. This double dilution represents a 100-fold dilution of the original sample. 2 ml of these diluted samples are put into standard COD test tubes. The test tubes are closed and shaken vigorously. The 13 (COD) test tubes (one is a control) are then heated to 150 deg. C for two hours. The UV spectrometer is calibrated by first analyzing the test tube with pure distilled water as the zero COD or control sample.

The sample test tubes are then analyzed for COD using UV spectrometer after inputting the method number and adjusting the frequency of UV rays to correspond to a sample with a high organic loading range. The readings that were obtained in units of mg/liter are multiplied by 100 to correct for the dilution procedure and to get COD concentration level for the original sample. COD is indicative of the organic substrate load level in the wastewater being treated or tested.

Formate ion concentration measurements

Formate ion concentration is measured using a DIONEX apparatus in the Environmental Engineering laboratory in Department of Civil Engineering at Texas Tech University. The apparatus was calibrated to measure formate ion concentration using four standard reference samples that contained a known concentration of formate ion. The know formate ion concentration levels were 25 ppm, 50 ppm, 75 ppm and 100 ppm. Since the original wastewater sample contained high solids (TS) levels, it was necessary to centrifuge the original sample to obtain a clear liquid layer. The liquid layer was then diluted by an appropriate proportion to account for the fact that the apparatus is only functionally calibrated to measure formate ion concentrations in wastewater samples in the range 0-100 ppm formate. The appropriately dilute liquid layer was then injected into the testing unit via a filter fitted syringe. The test apparatus is basically an ion chromatography column, which is connected to an analyzing computer via an appropriate electronic interface. The computer then directly analyzes the formate ion concentration in the original sample following a retention time of ˜20 minutes, for each sample that is injected.

Volumetric gas production measurements

The gases generated by the biological activity within the reactors were collected in the overhanging plastic bags. The bags are connected to a tank containing colored water via a gas port used for sampling purpose to determine the gas composition. To measure the volume of gas in the bag, the water in the tank is drained out maintaining a suction pressure head difference of 2 cm between the atmospheric air and the gas inside the tank. The water is drained until there is a jump in the pressure head differences, which is actually noted by observing a jump in the difference in levels of manometer limbs. This jump indicates that the gas in the bag has been completely transferred to the water tank. The difference between final water level and initial water level is measured by the scale on the side of the tank and is indicative of the volume of gas collected in each of the bags. The gas is returned to the bags by pumping the drained water back into the water tank, whereby the collected gas inside the water tank is pushed back into the overhanging plastic bags. The arrangement is shown in FIG. 4.

Anaerobic digestion

Anaereobic digestion is one of the oldest known processes used to treat organic waste. It involves the decomposition or organic and inorganic matter in the absence of molecular oxygen to produce methane and carbon dioxide.

Organic Matter_{(anaerobic digestion)}→CH₄+CO₂

Applications

The major application of anaerobic digestion has been the stabilization of the many concentrated sludge streams produced from the treatment of municipal and industrial wastewater. More recently it has been demonstrated that many low solids wastewater streams can also be successfully treated with an anaerobic digestion in a cost effective fashion.

Anaerobic v/s aerobic waste treatment

Anaerobic wastewater treatment has three advantages over aerobic wastewater treatment: The first advantage is the production of fuel gas in the form of methane to offset treatment costs. The second is a nearly 30% reduction of the total solids that need to be land filled. The third and final advantage is better fugitive odor control.

Economic ramifications of proposed formate additive approach

The economic advantages of the proposed formate salt additive for anaerobic methanogenesis lie in two areas. The first is the potential additional energy produced in the form of methane. The second advantage involves the reduction of the cost associated with handling reduced stabilized sludge volumes.

The proposed use of a formate salt additive was suggested by studies in ruminant animals. Adding sodium formate to organic roughage fed to cattle increased the digestibility of the feed from 4-27%. The mechanism by which digestibility is improved is currently unknown. Since many of the methanogenic organisms identified in mixed culture, anaerobic digesters are similar to those found in stomachs of ruminant animals, this suggested the possibility that adding sodium formate to a mechanical anaerobic digester might enhance the digestion and conversion of the organic loading in an influent wastewater stream to methane.

Gas composition measurements

To analyze the composition of the gases collected, a small sample of gas was withdrawn through a gas port and then sent out for analysis by a commercial laboratory utilizing gas chromatography.

pH measurements

The pH probe was calibrated several times with a 3-point calibration procedure that required using standard pH samples of strength 4.0, 7.0 and 10.0. The pH probe was then inserted into each aliquot sample that was withdrawn from a reactor to determine the pH of the sample.

Procedure for Bacterial Colony Counts from Formate Bioreactors

1. Collect samples from each bioreactor in sterile 30-mL glass vials with screw caps.

2. All subsequent operations are performed aseptically in the anaerobic chamber under an atmosphere of 3% H₂/7% CO₂/90% N₂.

3. Serially dilute 1.0-mL samples into 9.0-mL blanks containing 0.85% NaCI.

4. Seed 0.1-mL samples form the dilution blanks into tryptic soy agar plates.

5. Inoculate three plates for each dilution. Final dilutions on the plates are 10⁻³ and 10⁻⁴

6. Incubate all plates anaerobically for 3-4 days at room temperature (approximately 25° C.) prior to manually counting the numbers of colonies on each plate.

7. Calculate the numbers of colony-forming units (CFU) per ml in the original samples.

The following process variables were monitored:

1. Chemical Oxygen Demand (COD)

2. Total Solids (TS)

3. Total Volatile Solids (TVS)

4. Volumetric rate of gas production

5. Gas composition

6. pH of the reactor sample

7. Bacterial count of the reactor samples

8. Bacterial Identification in the digester sample.

Lab scale tests:

In bench scale anaerobic digesters, the gas production and waste degredation as a function of formate concentrations was investigated.

Municipal sludge from the city of Lubbock, Wastewater Treatment Plant was digested in 12 batch digesters. Using twelve batch reactors allowed the collection of control reactors data (i.e., no formate in the reactors) in triplicate, titration studies of increasing formate concentration, and duplicates/triplicates of varying formate concentration. Experiments were conducted in the laboratories of Texas Tech University.

### Results

The reactors were setup on Mar. 15, 1999 with one time addition of formate ion. The substrate taken was 2 parts of 50 g/liter sucrose solution mixed with 1 part of digested municipal sludge which acts as the seed material for incorporation of microbes into the reactors. The experiments were started with the following protocol.

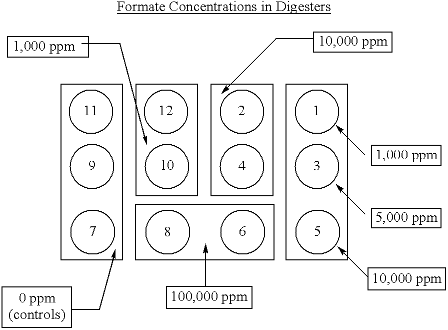

The process variables were measured periodically.

The preceding methods had the following results as shown in Tables 6-11 wherein Table 6 illustrates COD results using various formate salt concentrations in parts per million;

Table 7 illustrates total solids results using formate salt in parts per million concentrations for various reactors and days;

Table 8 illustrates total volatile solids with formate salt concentrations in parts per million results for various days and reactors;

Table 9 illustrates the results of volume and composition of gas generated for various formate salt concentrations in parts per million, different reactors and averages;

Table 10 illustrates pH results using formate salt concentrations in parts per million for various reactors and up to 55 days; and

Table 11 illustrates bacteria count results for various formate salt concentrations in parts per million as well as various reactors.

TABLE 6
Chemical Oxygen Demand (COD) Results

| | Chemical Oxygen Demand (g/liter) | | | | | | | | | | | |
|---|---|---|---|---|---|---|---|---|---|---|---|---|
| | Formate concentration, ppm | | | | | | | | | | | |
| | 0 | | | 1000 | | | 5000 | 10000 | | | 100000 | |
| | Reactor No. | | | Reactor No. | | | Reactor | Reactor No. | | | Reactor No. | |
| Days | 7 | 9 | 11 | 1 | 10 | 12 | 3 | 2 | 4 | 5 | 6 | 8 |
| with formate | 57.2 | 52 | 60.8 | 48.6 | 59.1 | 45.9 | 60.3 | 58.2 | 69 | 36.7 | 49 | 64.4 |
| addition at t = 0 | | | | | | | | | | | | |
| 1 | 57.0 | 51.5 | 60.3 | 57.2 | 51.9 | 51.7 | 46.8 | 50.7 | 52.3 | 45.5 | 120.7 | 165 |
| 4 | 49.8 | 52.0 | 51.4 | 52.3 | 50.3 | 51.4 | 48.9 | 47.3 | 43.5 | 43.2 | 65.5 | 87.1 |
| 7 | 56.6 | 65.8 | 68.2 | 50.3 | 53.9 | 52.3 | 52.2 | 56.4 | 56.4 | 44.3 | 74.9 | 94.5 |
| 9 | 52.1 | 54.9 | 48.5 | 47.7 | 52.0 | 50.5 | 44.2 | 49.9 | 51.6 | 43.7 | 71 | 89.6 |
| 16 | 30.9 | 33.1 | 41.4 | 33.6 | 32.0 | 32.9 | 30.4 | 38.2 | 32.0 | 40.0 | 57.5 | 67.1 |
| 24 | 28 | 59.2 | 11.2 | 39.4 | 14.2 | 20.7 | 30.9 | 40.8 | 37.1 | 40 | 41.5 | 25.6 |
| 55 | 41.9 | 34 | 46.6 | 36 | 36.9 | 33 | 34.3 | 49.7 | 38.5 | 32 | 64.8 | 73.9 |

TABLE 7
TS results

| | Total Solids (g/liter) | | | | | | | | | | | |
|---|---|---|---|---|---|---|---|---|---|---|---|---|
| | Formate concentration, ppm | | | | | | | | | | | |
| | 0 | | | 1000 | | | 5000 | 10000 | | | 100000 | |
| | Reactor No. | | | Reactor No. | | | Reactor | Reactor No. | | | Reactor No. | |
| Days | 7 | 9 | 11 | 1 | 10 | 12 | 3 | 2 | 4 | 5 | 6 | 8 |
| Formate | 39.1 | 40.4 | 39.1 | 42.3 | 41.8 | 40.8 | 47.5 | 54.9 | 53.4 | 55.1 | 180.4 | 188 |
| addition at t = 0 | | | | | | | | | | | | |
| 2 | 38.0 | 39.5 | 38.7 | 37.6 | 35.9 | 35.9 | 35.5 | 52.6 | 48.3 | 44.5 | 254 | 289.6 |
| 7 | 32.3 | 32.2 | 30.8 | 33.8 | 32.5 | 32.2 | 34.6 | 45.3 | 43.5 | 36.3 | 91.5 | 147.4 |
| 16 | 15.0 | 16.2 | 19.2 | 20.3 | 15.8 | 21.4 | 20.7 | 41.2 | 31.2 | 34.6 | 129 | 151.1 |
| 243 | 14.5 | 15.3 | 16.9 | 16.6 | 13.0 | 17.8 | 22.0 | 39.6 | 30.7 | 33.4 | 125 | 147.8 |
| 55 | 15.7 | 16.5 | 17.1 | 15.6 | 13.2 | 17.3 | 23.2 | 36.8 | 33.3 | 36.3 | 128 | 160 |

TABLE 8
TVS Results

| | Total Volatile Solids (g/liter) | | | | | | | | | | | |
|---|---|---|---|---|---|---|---|---|---|---|---|---|
| | Formate concentration, ppm | | | | | | | | | | | |
| | 0 | | | 1000 | | | 5000 | 10000 | | | 100000 | |
| | Reactor No. | | | Reactor No. | | | Reactor | Reactor No. | | | Reactor No. | |
| Days | 7 | 9 | 11 | 1 | 10 | 12 | 3 | 2 | 4 | 5 | 6 | 8 |
| With formate | 37.1 | 38.6 | 37.4 | 39.6 | 38.8 | 37.3 | 41.8 | 46.9 | 46.4 | 38.8 | 126.6 | 134.9 |
| addition at t = 0 | | | | | | | | | | | | |
| 2 | 36.6 | 39.0 | 37.7 | 33.4 | 32.6 | 26.7 | 23.7 | 30.2 | 29.8 | 25.5 | 68.5 | 80.8 |
| 7 | 30.1 | 30.4 | 29.0 | 30.6 | 29.9 | 29.3 | 20.3 | 24 | 24.1 | 19.2 | 45.8 | 52.7 |
| 16 | 13 | 13.7 | 16.8 | 16.4 | 13.1 | 18.1 | 12.6 | 21.0 | 15.0 | 17.1 | 44.7 | 54.10 |
| 24 | 12.5 | 13.5 | 15.2 | 14.4 | 10.3 | 15.2 | 11.7 | 18.9 | 15.2 | 16.4 | 41.4 | 51.6 |
| 55 | 13.7 | 14.1 | 14.9 | 12.9 | 10.7 | 14.2 | 14.7 | 20.1 | 18.5 | 19.8 | 45.5 | 65.8 |

TABLE 9
Volume and composition of gas generated

| | | | | | | Average | | | Volume |
|---|---|---|---|---|---|---|---|---|---|
| Formate | | Volume | | | | Composition | | | of CO₂ |
| Conc., | Reactor | of gas, | N₂ | CH₄ | CO₂ | CH₄ | N₂ | CO₂ | generated |
| ppm | No. | ml | % | % | % | % | % | % | (ml) |
| 0 | 7 | 3250 | 70 | 0 | 30 | 0 | 63.3 | 36.7 | 975 |
| 0 | 9 | 4000 | 72 | 0 | 28 | | | | 1120 |
| 0 | 11 | 35500 | 48 | 0 | 52 | | | | 18460 |
| 1000 | 1 | 50 | 60 | 0 | 40 | 0 | 71.7 | 18.3 | 20 |
| 1000 | 10 | 750 | 80 | 0 | 20 | | | | 154 |
| 1000 | 12 | 26600 | 75 | 0 | 25 | | | | 6783 |
| 5000 | 3 | 1750 | 59 | 0.1 | 41 | 0.1 | 59 | 41 | 725 |
| 10000 | 2 | 1300 | 43 | 0 | 57 | 0 | 58.3 | 41.7 | 728 |
| 10000 | 4 | 3250 | 57 | 0 | 43 | | | | 1398 |
| 10000 | 5 | 500 | 60 | 0 | 40 | | | | 200 |
| 100000 | 6 | 1300 | 30 | 0 | 70 | 0 | 41.5 | 59 | 910 |
| 100000 | 8 | 3500 | 53 | 0 | 47 | | | | 1663 |

The plots of gas volume, and total CO₂ production v/s formate concentration are shown in the following pages.

TABLE 10
pH results

| | pH | | | | | | | | | | | |
|---|---|---|---|---|---|---|---|---|---|---|---|---|
| | Formate concentration ppm | | | | | | | | | | | |
| | 0 | | | 1000 | | | 5000 | 10000 | | | 100000 | |
| | Reactor No. | | | Reactor No. | | | Reactor | Reactor No. | | | Reactor No. | |
| Days | 7 | 9 | 11 | 1 | 10 | 12 | 3 | 2 | 4 | 5 | 6 | 8 |
| No formate | 8.1 | 8.03 | 8.09 | 8.02 | 8.03 | 8.03 | 8 | 7.98 | 7.97 | 8.07 | 8.06 | 7.99 |
| 0 (with formate) | 8.02 | 8.04 | 8.08 | 5.30 | 5.21 | 5.22 | 5.08 | 6.42 | 6.29 | 6.50 | 7.54 | 7.75 |
| 2 | 4.55 | 4.51 | 4.60 | 4.72 | 4.77 | 4.82 | 5.08 | 5.64 | 5.49 | 5.51 | 7.34 | 7.54 |
| 3 | 4.40 | 4.30 | 4.40 | 4.52 | 4.57 | 4.66 | 4.85 | 5.28 | 5.1 | 5.18 | 7.33 | 7.46 |
| 5 | 4.27 | 4.15 | 4.27 | 4.43 | 4.47 | 4.53 | 4.76 | 5.25 | 5.1 | 5.19 | 7.34 | 7.5 |
| 7 | 4.11 | 4.01 | 4.09 | 4.20 | 4.26 | 4.27 | 4.5 | 5.01 | 4.97 | 4.78 | 7.25 | 7.42 |
| 9 | 4.01 | 3.87 | 3.98 | 4.06 | 4.13 | 4.16 | 4.37 | 4.67 | 4.69 | 4.48 | 7.27 | 7.42 |
| 17 | 3.57 | 3.55 | 3.51 | 3.83 | 3.88 | 3.71 | 4.0 | 4.21 | 4.55 | 4.21 | 6.3 | 6.87 |
| 25 | 3.44 | 3.44 | 3.41 | 3.53 | 3.68 | 3.61 | 3.99 | 4.17 | 4.19 | 4.13 | 6.01 | 6.72 |
| 55 | 3.46 | 3.42 | 3.41 | 3.59 | 3.76 | 3.61 | 4.06 | 4.25 | 4.25 | 4.21 | 5.97 | 6.73 |

TABLE 11
Bacterial Count Results

| Formate | | Colony forming units per mL |
|---|---|---|
| Concentration | Reactor Number | (× 10⁷) |
| 0 | 7 | 1.9 |
| 0 | 9 | 1.8 |
| 0 | 11 | 1.9 |
| 1000 | 1 | 1.1 |
| 1000 | 10 | 6.0 |
| 1000 | 12 | 1.4 |
| 5000 | 3 | 0.59 |
| 10000 | 2 | 0.26 |
| 10000 | 4 | 0.19 |
| 10000 | 5 | 0.38 |
| 100000 | 6 | 0.04 |
| 100000 | 8 | 0.38 |

Procedure for Gram Stain

1. Put one drop of distilled water onto a microscope slide.

2. Streak the bacteria colony onto the water droplet.

3. Let the slide air dry.

4. Heat-treat the slide by passing it across flame for 2-3 times.

5. Put one drop of Crystal Violet and let it sit for a minute, then rinse off with water.

6. Put one drop of Gram's Iodine and let it sit for a minute, then rinse it off with water.

7. Decolorize the colony by adding, drop-by-drop, the de colorizer (alcohol) until it runs clean off the slide.

8. Rinse off the slide with water.

9. Put one drop of Safranin and let it sit for a minute, then rinse it off with water.

10. The bacteria colony is ready to be examined under the microscope.

Gram Stain Results

| Colony | | |
|---|---|---|
| Number | Shape | Type (Gram positive or negative) |
| 1 | Thin rod | negative |
| | Plump rod | positive |
| 2 | thin rod | negative |
| 3 | thin rod | variable (+/−) |
| 4 | thin rod | negative |
| 5 | thin rod | negative |
| 6 | plump rod | negative |
| 7 | thin rod | positive |

It is to be understood that the above described embodiments of the invention are illustrative only, and that modifications thereof may occur to those skilled in the art: Accordingly, this invention is not be regarded as limited to the embodiments disclosed herein, but it is to be limited only as defined by the appended claims.

1. An anaerobic digester additive to be used for improved anaerobic digestion of water borne biomass, wastewater, comprising:
A presence of at least about 100 mg/L or greater of a formate salt or mixtures of formate salts, said presence being based on total solids content of the biomass (COD level), the formate salts stimulating the anaerobic microbial activity in an anaerobic digestion zone promoting reduction of residual sludge of the biomass in the wastewater and reduction of chemical oxygen demand for the wastewater used in the digestion.

2. An anaerobic digester additive for anaerobic digestion of organic biomass in waste water according to claim 1 wherein the formate salt or mixtures of formate salts are selected from the group consisting of sodium formate, potassium formate, calcium formate, and ammonium formate

3. An anaerobic digester additive that is to be used in anaerobic digestion of organic biomass according to claim 1 wherein the organic biomass is in a wastewater carrier and the formate salts or mixtures of formate salts provide a faster rate of reduction of biochemical oxygen demand level in the wastewater.

4. An anaerobic digester additive to be used for control of pH levels in the anaerobic digestion of organic biomass according to claim 1 wherein the total suspended solids in the wastewater biomass sludge are reduced by at least 10 percent or greater; said formate salt additive also assists in managing pH control in the digester targeting the 6.8 to 7.4 pH range for optimum anaerobic digestion.

5. A formate salt anaerobic digestor additive for anaerobic digestion of organic biomass in wastewater according to claim 1 wherein the formate salts increases the anaerobic microbial activity of the anaerobic digester and effectively increases the capacity of the digester zone through promoting a significantly greater reduction of residual sludge and the reduction of biochemical oxygen demand levels of the wastewater and doing so at a faster rate.

6. A formate salt anaerobic digestor additive for anaerobic digestion of organic biomass in wastewater streams according to claim 1 wherein the formate salts are used to enhance anaerobic digestion of agricultural wastewaters and sludge and reduce the amounts of sludge solids that remains following digestion with the formate salt additive.

7. A formate salt anaerobic digestor additive for anaerobic digestion of organic biomass in wastewater streams according to claim 1 wherein the formate salts are utilized in enhancing anaerobic microbial activity in a domestic, “septic tank”, anaerobic digester.

8. An anaerobic digestor additive for anaerobic digestion of organic biomass according to claim 1 wherein the biomass is water-borne in the presence of about 500 to 1000 mg/L or greater of the formate salt, or mixtures of the formate salts are utilized based on total solids content of the biomass sludge contained in the wastewater.

9. An anaerobic digestor additive for anaerobic digestion of organic biomass in wastewater streams according to claim 1 wherein the biomass is water-borne in the presence of about 1000 to about 10,000 mg/L or greater of the formate salt or mixtures of formate salts are utilized based on total solids content of the biomass sludge.

10. An anaerobic digestor additive according to claim 2 wherein the formate salt is sodium formate.

11. An anaerobic digestor additive according to claim 2 wherein the formate salt is potassium formate.

12. A method for enhancing anaerobic microbial activity in anaerobic digester for water-borne organic biomass comprising:
Mixing with the water-borne organic biomass at least about 100 mg/L based on total solids content of the biomass of formate salts, the formate salts reducing the biochemical oxygen demand (BOD) level of the digester and by conversion of at least 10 percent or greater the amount of biomass sludge solids to dissolved solids resulting in a reduction of sludge following digestion.

13. A method according to claim 12 wherein the formate salts additive to wastewater borne organic biomass sludge increases capacity of the digester through enhancement of the anaerobic microbial activity in the anaerobic digester.

14. A method according to claim 12 wherein the formate salts are produced insitu by adding formic acid and in a percentage of at least about 100 mg/L based on total solids content wherein the biomass and digester environment is being maintained at pH levels in the range of 6.8-7.4 pH.

15. A method according to claim 12 wherein a base such as sodium hydroxide, potassium hydroxide, calcium hydroxide, or ammonium hydroxide is added to a water-borne organic biomass that has been treated with formic acid so as to produce formate salts insitu, the formate salts then enhancing the anaerobic microbial activity in the anaerobic digester and promoting the digestibility of the biomass resulting in reduction of sludge after digestion.
